(19) United States
(12) Patent Application Publication
(10) Pub. No.: US 2006/0174112 A1
(43) Pub. Date: Aug. 3, 2006

(54) Secure computer communication

(75) Inventor: Stuart Charles Wray, Dorset (GB)

Correspondence Address: CROWELL & MORING LLP;INTELLECTUAL PROPERTY GROUP, P.O. BOX 14300, WASHINGTON, DC, 20044-4300, US

(73) Assignee: BAE Systems (Defence Systems) Limited, Hampshire (GB)

(21) Appl. No.: 10/529,303

(22) PCT Filed: Feb. 23, 2005
(86) PCT No.: PCT/GB05/00644

§ 371 Date: Mar. 25, 2005

(30) Foreign Application Priority Data
Feb. 27, 2004 (GB) 0404444.2

(51) Int. Cl. H04L 9/00

(52) U.S. Cl. 713/168

(57) ABSTRACT

A method of improving the security of computer communications over a connecting network comprising the steps, carried out before a data packet enters the connecting network from a user domain, of tagging the data packet from a user domain with a security level marking and appending the tagged data packet with a string formed from a check-sum made over the data packet and security level marking tag to form a datagram. The integrity of the data is protected and the method can be used to prevent the mis-routing of data packets to user domains of lower security classification.

The present invention relates to a method for secure communication between computer user domains, particularly to the application of domain separators to ensure secure communication across networks.

Computing systems often comprise user domains (whether a computer or a network of computers) of different security classification on connecting networks. There is then a need to protect data communicated between user domains of the same classification from unauthorised access, whether unauthorised persons in user domains of lower classification or potential unauthorised persons in the connecting network.

Previously, user domains with different security levels have been placed on different connecting networks to prevent data packets being mis-routed to a user domain of lower security classification. However, this is disadvantageous as it does not allow bandwidth to be shared between the different security levels.

Encrypting data prior to sending it on an unsecured medium allows bandwidth to be shared. A cryptograph is used to protect the data from potential unauthorised persons in the connecting network as well as to separate user domains of different classifications from each other. While attempts to encrypt data to improve security have had some commercial success, the cryptographic devices required for high security systems are costly and difficult to produce. This is due to the need for high security system cryptographs to meet stringent requirements for reliability of implementation. These requirements are extremely difficult to satisfy in devices as complex as cryptographs, particularly with respect to cryptographic key management functions. Less robust cryptographs, while good enough for most applications, are not acceptable for use in high security systems.

There is therefore a need for an improved method of communication between user domains that provides a high degree of security in data transfers.

Accordingly, the present invention provides a method of improving the security of computer communications over a connecting network comprising the steps carried out before a data packet enters the connecting network from a user domain, of (a) tagging the data packet with a security level marking and (b) appending the tagged data packet with a string formed from a check-sum made over the data packet and security level marking tag, to form a datagram. The string may comprise a check-sum or part of a check-sum. While not all the bits of a check-sum are required, enough bits must be used to ensure that the probability of failure due to accidental packet corruption is less than a desired threshold.

Preferably, as the datagram attempts to enter a second user domain, the method comprises the further steps of: (c) verifying the string in the received datagram matches a string calculated over the received data packet and security level marking tag and (d) verifying the received security level marking tag matches the security level of the second user domain.

Advantageously, the datagram is encrypted before entry into the connecting network. This further secures the data from unauthorised access.

Optionally, datagrams from more than one user domain are encrypted by the same cryptograph. This reduces the number of cryptographs required.

Advantageously, the string made over the data packet and security level marking tag is a one-way hash function and preferably the one-way hash function is SHA-1.

Preferably, the method further comprises the step of recording any mismatch between the string in the received datagram and a string calculated over the received data packet and security level marking tag, and any mismatch between the received security level marking tag and the security level of the second user domain. Such a security event register provides a log of data packet mis-routing or corruption.

In a further embodiment, the present invention provides a domain separator for improving the security of computer communications over a connecting network arranged to carry out the method as described above.

Optionally, the user domain security level is set by a physical switch on the domain separator. Access to the physical switch can then be restricted by physical security controls.

The invention will now be described by way of example only and with reference to the accompanying drawings, in which:

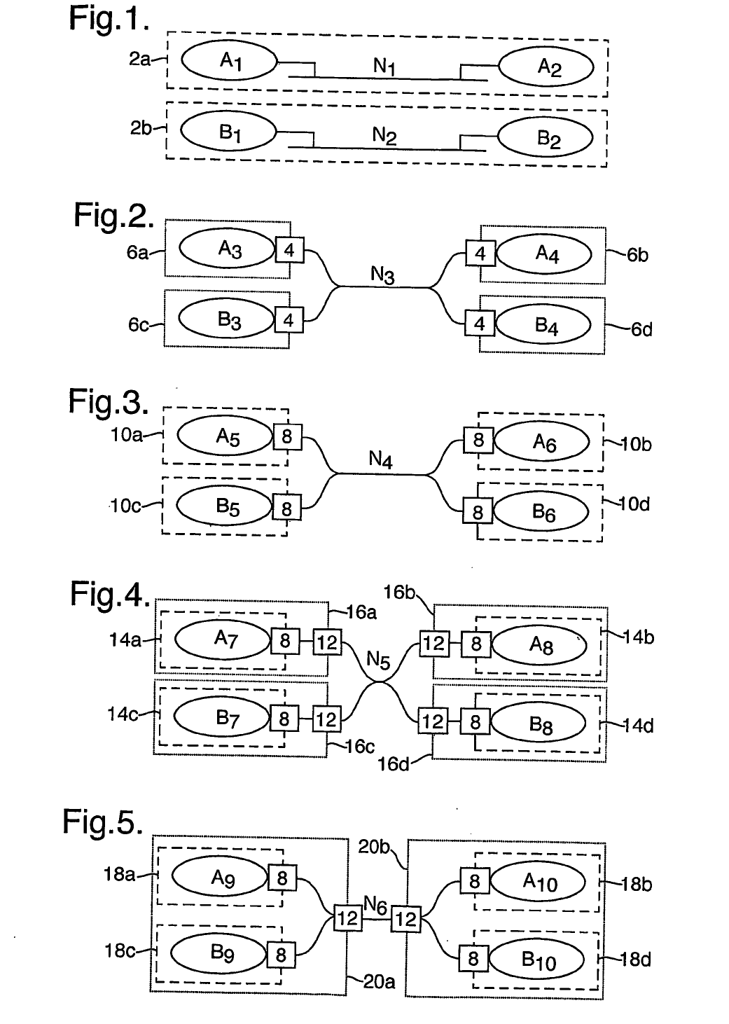

FIG. 1 is a schematic view of one embodiment of the prior art;

FIG. 2 is a schematic view of an alternative prior art system;

FIG. 3 is a diagrammatic illustration of an embodiment of the invention;

FIG. 4 is a schematic view of another embodiment of the invention; and

FIG. 5 is a schematic view of a further embodiment of the invention.

In FIG. 1, user domains A₁ and A₂ with security classification level 1 (SCL1) are on a connecting network N₁ and user domains B₁ and B₂ with security classification level 2 (SCL2) are on a different connecting network N₂. SCL1 data packets can be communicated between A₁ and A₂, without the possibility of mis-routing to B₁ or B₂. Similarly, SCL2 data packets can be communicated between B₁ and B₂ without the possibility of mis-routing to A₁ or A₂. Therefore, the data is protected from unauthorised persons in user domains viewing material at a classification level higher than that to which the person is cleared. This system relies on the managers of networks N₁ and N₂ having authorisation to view SCL1 and SCL2 data packets respectively. Persons within the dashed lines 2a must be authorised to see at least SCL1 and persons within dashed lines 2b must be authorised to see at least SCL2. A system having different security levels separated onto different networks is disadvantageous as bandwidth cannot then be shared between the security levels.

FIG. 2 illustrates a system architecture according to the prior art, involving the use of encryption, which circumvents the problem of bandwidth sharing. User domains A₃, A₄, B₃ and B₄ are all connected to one connecting network N₃. Plain text data within the dotted lines 6a, 6b, 6c and 6d is encrypted on leaving each user domain via cryptographs 4. For certain high security systems the cryptographs 4 must meet high reliability requirements for security certification. Unauthorised persons in the connecting network N₃ are unable to read the encrypted data. User domains with security classification lower than that of the sender are unable to access the data as they do not hold the correct cryptographic key. As network N₃ is shared between the different classifications, the use of bandwidth is more efficient. However, this system relies on costly cryptographic devices certified for use in high security systems.

The present invention allows network bandwidth to be shared between data packets of different classifications while keeping user domains of higher security classification separate from those of lower classification. The mis-routing of data packets to user domains of lower security classification is prevented as is the delivery of corrupted data packets. In the embodiment of the present invention shown in FIG. 3, a domain separator 8 encapsulates data packets from user domains A₅, A₆, B₅, B₆ with a security tag, giving an indication of the security classification of the data packet. The security tag is based on a physical switch (not shown) setting within the domain separator 8. There is no effective way for someone in a user domain to attack the domain separator without having physical access to it. In particular, the security tag is based on a physical switch setting in the domain separator which can be secured.

A check-sum is then made over the data packet and security tag for transport across a connecting network N₄. A string comprising the hash, or part of the hash, is appended to the tagged data packet. A hash may comprise of, for example, 160 bits. While not all the bits are required, enough bits must be used to ensure that the probability of failure due to accidental packet corruption is less than a desired threshold. The datagram, comprising the data packet with the security tag and the string then enters the connecting network N₄.

The check-sum algorithm is a one-way hash function, a mathematical function which operates on an arbitrary-length pre-image message and converts it into a fixed-length binary sequence, known as the hash. The one-way aspect (known as pre-image resistance) means that it is computationally infeasible to reverse the process, that is, to find a string that hashes to a given value. With a good hash function it is computationally infeasible to find two strings which produce the same hash (known as second pre-image resistance). Small changes in an input string produce large changes in the hash. A domain separator with such a one-way hash function protects the data from unauthorised persons in the connecting network, provided the check-sum algorithm is not known to the unauthorised persons, and from accidental transport from one user domain to another of lower classification.

The preferred one-way hash function is SHA-1 (as described in the National Institute of Standards and Technology's Federal Information Processing Standards Publication 180-1) but alternatives may be used. Alternatively, a check-sum that is not a one-way hash function may be used in a domain separator that protects the data from accidental transport from one user domain to another of lower classification.

On arrival of the datagram at a destination user domain, the domain separator 8 for the destination domain removes the string from the datagram and compares it to a newly computed string of the remainder of the datagram. If the string comprises part of a hash, the same specific part of the newly computed hash is compared to the part of the hash appended to the tagged data packet. The security tag of the datagram is compared to the security setting of the destination domain separator 8. If both the security tag and the string are correct, the original data packet is delivered.

A domain separator protects the integrity of the data it encapsulates, rather than the confidentiality. It also protects the integrity of the security tag which records the protective marking of the material.

If a data packet is mis-routed in the connecting network and is delivered in error to a user domain with the wrong security level, the domain separator 8 at the destination will discard the packet if the security tag of the data packet does not match the switch setting at the destination.

Similarly, if a data packet is corrupted in transit (including corruption of the security tag) then the string in the data packet will not match the string calculated at the destination and the packet will be dropped.

A security event register (not shown) logs security events such as the discard of data packets by a domain separator.

The connecting network N₄ can be physically secured, for example riveted in conduits on a ship or in a building, to prevent access to the multi-level plain text connecting network.

Persons within the dashed lines 10a, 10b, 10c and 10d in FIG. 3 must be cleared to the security classification level of the user domains A₅, A₆, B₅ and B₆, respectively. Managers of the connecting network N₄ must be cleared to the highest security classification level in the system.

If the connecting network managers are trusted, the domain separator algorithm for calculating the check-sum algorithm may be publicly known. However, if the connecting network managers can be trusted to see the data sent from one user domain to another but cannot be trusted not to corrupt the data packet (for example, changing the data packet security tag to redirect the data packet to the wrong domain), the check-sum algorithm should not be publicly known. Alternatively, encryption can be used to protect the data from unauthorised persons in the connecting network, as shown in FIGS. 4 and 5. The use of encryption not only prevents connecting network managers corrupting data packets but also prevents the managers from viewing the data. If the data is encrypted the check-sum algorithm can be published.

The datagram, comprising the data packet with the security tag and the hash, is encrypted on leaving the domain separator 8 before entry into the connecting network (N₅ in FIG. 4, N₆ in FIG. 5). The cryptographs 12 can be assigned to each user domain (A₇, A₈, B₇, B₈ in FIG. 4) or to groups of user domains as illustrated in FIG. 5, with one cryptograph 12 assigned to A₉ and B₉ and a second cryptograph 12 assigned to A₁₀ and B₁₀. While each of the domain separators and cryptographs are referred to by the numerals 8 and 12 respectively in the figures, it is to be understood that the invention is not limited to the use of one type of domain separator or cryptograph in each embodiment.

On arrival of the encrypted datagram at a destination user domain, the datagram is decrypted and the domain separator 8 for the destination domain verifies the check-sum and security level marking tag as described above before either allowing the data packet to enter the user domain or discarding the data packet.

Persons within dashed lines 14a, 14b, 14c, 14d, 18a, 18b, 18c and 18d must be cleared to the security classification level of user domains A₇, A₈, B₇, B₈, A₉, A₁₀, B₉ and B₁₀, respectively.

The domain separator, at the exit point of each user domain, provides a means of preventing data packets from being mis-routed to user domains of lower security classification. It is easier to produce a domain separator certified for use in high security systems than it is to produce a cryptograph certified for use in high security systems because the domain separator performs a simpler function and has no key management function. The cryptographs 12 used in conjunction with domain separators 8 are used to protect the data from unauthorised persons in the connecting network. Data packets outside dotted lines 16a, 16b, 16c, 16d, 20a and 20b are protected from unauthorised persons in the connecting network N₅ or N₆. As the cryptographs 12 in the present invention are not used for preventing the incorrect delivery of data packets, they need not meet requirements for reliability of implementation as stringent as those needed by cryptographs 4 in prior art systems where the cryptographs 4 are also used to prevent the mis-routing of data packets.

1. A method of improving the security of computer communications over a connecting network comprising the steps carried out before a data packet enters the connecting network from a user domain of:
a) tagging the data packet from a user domain with a security level marking, and
b) appending the tagged data packet with a string formed from a check-sum made over the data packet and security level marking tag to form a datagram.

2. A method as claimed in claim 1, comprising the further steps, carried out as the datagram attempts to enter a second user domain, of:
c) verifying the string in the received datagram matches a string calculated over the received data packet and security level marking tag, and
d) verifying the received security level marking tag matches the security level of the second user domain.

3. A method as claimed in claim 1, comprising the further step of encrypting each datagram before entry into the wide area network.

4. A method as claimed in claim 3, wherein datagrams from more than one user domain are encrypted by the same cryptograph.

5. A method as claimed in claim 4, wherein the check-sum is a one-way hash function.

6. A method as claimed in claim 5, wherein the one-way hash function is SHA-1.

7. A method as claimed in claim 6, further comprising the step of recording any mismatch of check-sum or security level marking tag.

8. A domain separator for improving the security of computer communications over a connecting network arranged to carry out the method according to claim 7.

9. A domain separator as claimed in claim 8, wherein the user domain security level marking is set by a physical switch on the device.

10. A method as claimed in claim 1, wherein the check-sum is a one-way hash function.

11. A method as claimed in claim 10, wherein the one-way hash function is SHA-1.

12. A method as claimed in claim 11, further comprising the step of recording any mismatch of check-sum or security level marking tag.

13. A domain separator for improving the security of computer communications over a connecting network arranged to carry out the method according to claim 12.

14. A domain separator as claimed in claim 13, wherein the user domain security level marking is set by a physical switch on the device.

15. A method as claimed in claim 2, further comprising the step of recording any mismatch of check-sum or security level marking tag.

16. A domain separator for improving the security of computer communications over a connecting network arranged to carry out the method according to claim 15.

17. A domain separator as claimed in claim 16, wherein the user domain security level marking is set by a physical switch on the device.
